(19) United States
(12) Patent Application Publication
(10) Pub. No.: US 2024/0296104 A1
(43) Pub. Date: Sep. 5, 2024

(54) BEHAVIOR-BASED DETECTION OF AUTOMATED SCANNER EVENTS

(71) Applicant: Salesforce, Inc., San Francisco, CA (US)

(72) Inventors: Max Fleming, San Francisco, CA (US); Yuxi Zhang, San Francisco, CA (US); Kexin Xie, San Mateo, CA (US)

(21) Appl. No.: 18/116,644

(22) Filed: Mar. 2, 2023

(51) Int. Cl. G06F 11/30; G06F 11/34

(52) U.S. Cl. CPC G06F 11/3006; G06F 11/3438

(57) ABSTRACT

Methods, systems, apparatuses, devices, and computer program products are described. An application server or another device may receive a set of input data associated with an activity between an actor and an electronic communication message (e.g., a marketing email). From the input data, the application server may identify a set of features associated with the activity (an open rate, a click rate, etc.) and a set of source network addresses of respective, known automated scanners. The application server may input the features and source network addresses into a positive-and-unlabeled (PU) learning model, which may output a classification result that indicates a probability that the activity is associated with an automated scanner.

### FIELD OF TECHNOLOGY

The present disclosure relates generally to database systems and data processing and more specifically to behavior-based detection of automated scanner events.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

The cloud platform may support systems that are used to detect whether an actor engaging with an email is a human user or an automated scanner (e.g., a bot). Some approaches for detecting automated scanner activity may include short-term temporal-based approaches, which may be based on assuming that automated scanner engagement is characterized by short bursts of activity, and filtering-based approaches, which may classify actors as automated scanners based on comparing email events to a pre-set list of automated scanner activities. However, each of these approaches may have limitations. For example, the short-term temporal-based approaches may over-simplify characteristics of automated scanner activity, and thus, may mischaracterize human users as automated scanners in some cases. Additionally, the success of the filtering-based approach may depend how well the pre set list is maintained, which may be computationally and resource intensive. As such, current techniques may lack the ability to accurately identify an automated scanner based on tracking short-term engagement activities associated with emails.

### BRIEF DESCRIPTION OF THE DRAWINGS

FIG. 1 illustrates an example of a data processing system that supports behavior-based detection of automated scanner events in accordance with aspects of the present disclosure.

FIG. 2 illustrates an example of a computing architecture that supports behavior-based detection of automated scanner events in accordance with aspects of the present disclosure.

FIG. 3 illustrates an example of a system architecture that supports behavior-based detection of automated scanner events in accordance with aspects of the present disclosure.

FIG. 4 illustrates an example of a training algorithm that supports behavior-based detection of automated scanner events in accordance with aspects of the present disclosure.

FIG. 5 illustrates an example of a process flow that supports behavior-based detection of automated scanner events in accordance with aspects of the present disclosure.

FIG. 6 illustrates a block diagram of an apparatus that supports behavior-based detection of automated scanner events in accordance with aspects of the present disclosure.

FIG. 7 illustrates a block diagram of a data processor that supports behavior-based detection of automated scanner events in accordance with aspects of the present disclosure.

FIG. 8 illustrates a diagram of a system including a device that supports behavior-based detection of automated scanner events in accordance with aspects of the present disclosure.

FIGS. 9 through 11 illustrate flowcharts showing methods that support behavior-based detection of automated scanner events in accordance with aspects of the present disclosure.

### DETAILED DESCRIPTION

Some systems (e.g., artificial intelligence systems supporting customer relationship management (CRM) and one or more datasets) may support a user-friendly, interactive data analytics application. Such an application may receive a request to run one or more artificial intelligence models (such as a classification model) on different data sets. As one example, a user (e.g., a marketer) may input a request to run a classification model into a data analytics application running on a user device. In some cases, the data analytics application on the user device may transmit the request to a server (such as an application server). Additionally, or alternatively, a first server may transmit a classification request to a second server (e.g., an application server) based on receiving data from a load balancer.

In some examples, the application server may receive an activity message associated with an interaction with an electronic communication message (e.g., an email). The application server, upon receiving the request, may identify at least a source identifier of the activity message and one or more attributes associated with the electronic communication message. The interaction with the electronic communication message may be generated by an automated scanner (e.g., an automated security scanner, a bot) instead of a user. For example, an automated scanner may open an email, click a link within an email, click an invisible link within an email, or some combination of these actions. However, conventional systems may falsely identify an interaction generated by a human user as an interaction generated by an automated scanner, or may over-simplify characteristics of automated scanner activities. It may therefore be desirable to develop more robust techniques that pre-process network traffic as known automated scanner events or potential human events to classify activities as being associated with an automated scanner.

Marketing emails may include tracking features that inform a sender (e.g., a marketer) when an email is either opened or clicked by a recipient. Marketers may be interested in key performance indicators (KPIs) (such as open rates, click rates, and unsubscribe rates, among other tracking features) that may be calculated using aggregations of the tracking features. For example, a click rate may equal a quantity of emails that were clicked divided by a total quantity of emails that were sent. In some examples, a marketer may use the tracking features to determine whether a user is engaged with an email. However, these tracking features can be inadvertently affected by automated scanners (e.g., email security scanners, bots). Typically, email security scanners are configured to open an incoming email prior to delivering the email to a recipient's inbox. Email security scanners are often deployed in a workplace environment, where each incoming email is scanned for malicious content prior to it being delivered to an employee's inbox. Additionally, email security scanners may also visit Uniform Resource Locators (URLs) embedded in incoming emails to scan for malicious content. Such activity of the email security scanners may result in skewed engagement metrics calculated by a marketer. For instance, a marketer may erroneously identify an activity from an automated scanner as an activity from an intended recipient.

In some cases, a marketer may identify an activity from an automated scanner as a human activity, and may tailor targeted emails based on the activity. It may be difficult for marketers to block these automated security scanners (e.g., email security scanners) at a network level. Often times, such automated scanners may be hosted by cloud providers on IP addresses that tend to change, or by institutions that put these scanner behind the same network interface as their users. Blocking the automated scanners at a network level may also result in blocking legitimate users at the network level. Thus, there exists a need to detect and filter network traffic generated from automated scanners.

According to one or more aspects of the present disclosure, a device (e.g., a user device, server, server cluster, database, etc.) may use the described techniques to perform behavior-based detection of automated scanner events via an artificial intelligence system. Specifically, the described techniques for automatic scanner event-detection may account for varying behavioral, temporal, and attribute-based factors while predicting a likelihood that an actor behind an event (e.g., an email engagement) is an automated scanner. An artificial intelligence system (such as an artificial intelligence system hosted at an application server) may pre-process network traffic (e.g., a set of input data) into a set of behavioral features associated with an email engagement activity and a set of known automated scanner events. For example, the set of behavioral feature may include open rates, click rates, and unsubscribe rates, among other tracking features, and the set of known automated scanner events may be based on a pre-established list of IP addresses or user agents of previously-identified automated scanners.

The artificial intelligence system may utilize the pre-processed network traffic in a positive-and-unlabeled (PU) learning model (e.g., machine learning algorithm) that is previously trained on other input data. The PU learning model may output a classification result that classifies an email activity as being performed by a human user or an automated scanner. In classifying the activity, the PU learning model may output a classification result indicating a probability that the activity was associated with an automated scanner. In this way, a marketer may use the artificial intelligence system and the PU learning model for data analysis and predictive purposes. For example, based on the classification result indicating a high probability that an activity is associated with an automated scanner, the marketer may refrain from sending future emails to a source network address corresponding to the automated scanner.

Aspects of the disclosure are initially described in the context of an environment supporting an on-demand database service. Aspects of the disclosure are then described in the context of computing architectures, system architectures, training algorithms, and process flows. Aspects of the disclosure are further illustrated by and described with reference to apparatus diagrams, system diagrams, and flowcharts that relate to behavior-based detection of automated scanner events.

The techniques described herein for behavior-based detection of automated scanner events may result in one of the following potential improvements. In some examples, the techniques described herein may account for multiple factors (e.g., the set of features) known to be indicative of automated scanner behavior, which may improve the accuracy of identifying automated scanners. In addition, the described techniques rely on a variety of behavioral features, which may generalize a definition of non-human actors and automatically adapt to new automatic scanner behaviors as they evolve over time. Additionally, the described techniques may enable marketers to identify automated scanner actor attributes that were previously unknown, enabling continuous updating of a list of known automated scanner attributes as privacy and security tools evolve. This may increase transparency about the probability of detected bot activity. In addition, the described techniques may utilize probabilistic outputs to allow marketers to tune a model to be more or less aggressive in its actor identification depending on a use case.

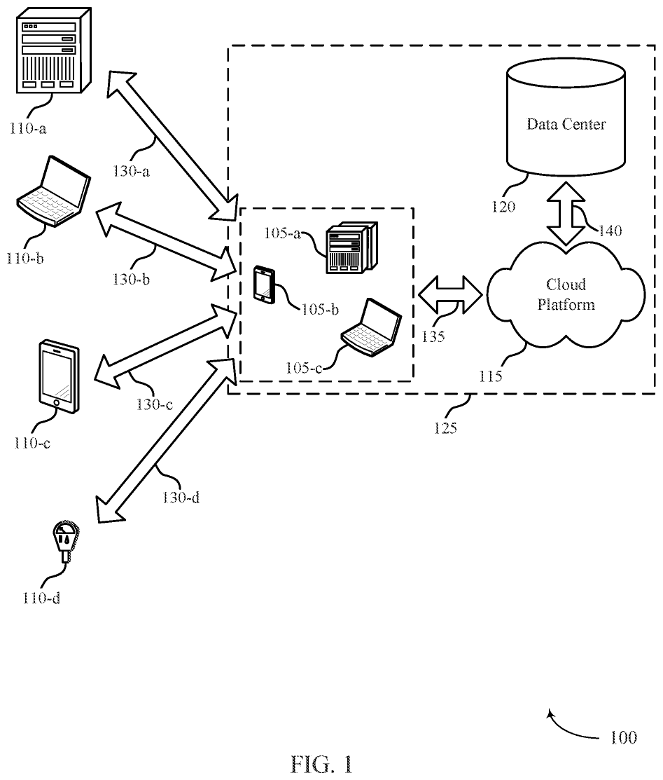

FIG. 1 illustrates an example of a system 100 for cloud computing that supports behavior-based detection of automated scanner events in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b. 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In some cases, CRM solutions, among other solutions (e.g., marketing solutions, etc.), may benefit from data analytics. Applications supporting artificial intelligence-enhanced data analytics may greatly increase the scope of data processing and model generation by automating much of the data analysis process. For instance, data analysis related to marketing emails or other electronic communication messages may be used to develop marketing models for users. Marketing emails may include tracking features that inform a sender (e.g., a marketer) when an email is either opened or clicked by a recipient. In some cases, these tracking features can be inadvertently affected by automated scanners (e.g., email security scanners).

In some examples, automated scanners may be deployed to identify malicious content included in an email. Additionally, or alternatively, automated scanners (such as email security scanners) may determine whether an email includes a spam email. In some cases, automated scanners may open an incoming email prior to delivering the email to the recipient's inbox. Additionally, or alternatively, automated scanners may also open a link included in an email to verify whether the link is legitimate.

A device (e.g., any component of subsystem 125, such as a cloud client 105, a server or server cluster associated with the cloud platform 115 or data center 120, etc.) may perform procedures to provide security for filtering network traffic from automated scanners. In some examples, the device (e.g., a user device, server, server cluster, database, etc.) may determine an actor behind an electronic communication message event (e.g., an open, a click, etc.) to detect engagement activity from automated scanners. For example, when an embedded tracking pixel in an email is triggered, the actor who triggered the event may be a human user opening an email or a web proxy service that cashes tracking pixels. In another example, if a link in an email is clicked, the actor may be a human user clicking to a web page or an automated scanner looking for phishing attacks. Accordingly, knowing the actor behind an electronic communication message event may be useful in a variety of use cases, such as follow-up messaging and obtaining true user-engagement measurements.

Some conventional systems may implement data analytics applications that fail to sufficiently filter network traffic generated by automated scanners. For example, marketers may use data analytics applications to analyze engagement metrics associated with marketing emails. Often times, marketing emails may include tracking features that inform a sender (e.g., a marketer) when an email is either opened or clicked by a recipient. Marketers may be interested in key performance indicators (KPIs) (such as open rates, click rates, and unsubscribe rates, among other tracking features) that may be calculated using aggregations of the tracking features. For example, a click rate may equal a quantity of emails that were clicked divided by a total quantity of emails that were sent. In some cases, a marketer can gather data associated with click rates in a marketing email (e.g., a rate of clicking on a URL embedded within a marketing email) and may develop marketing strategies based on the click rates. For example, the marketer may determine that a user has clicked on a URL related to a particular product. In such an example, the marketer may decide to increase marketing efforts directed towards that product. That is, in conventional systems, a marketer may use the tracking features to determine whether a user is engaged with an email, and if the marketer determines that the user is engaged with the email, then the marketer may develop a marketing strategy based on the engagement.

Specifically, some conventional systems may use short-term, temporal-based approaches to determine whether a human user or an automated security scanner is an actor behind an electronic communication message event. Short-term, temporal-based approaches operate on an assumption that automated scanner activity is seen in short bursts, for example, multiple emails being opened across multiple users nearly simultaneously. These solutions may use a cache to track recent events, and events that enter the cache with similar attributes (e.g., an IP address or user agent) may be classified as being associated with an automatic scanner. However, the assumption that automated scanner activity occurs in short bursts may mistakenly identify human actors as automated scanners in examples such as a user clicking a link in an email and repeatedly refreshing a webpage until it loads.

Some other conventional systems may use filtering-based approaches to determine whether a human user or an automated security scanner is an actor behind an electronic communication message event. For filtering-based approaches, the device may use a pre-set list of IP addresses, user agents, or both associated with known (e.g., previously identified) automated scanners and other bots. Events that are associated with an IP address (e.g., a source network address) that matches that on the pre-set list may be classified as automated scanner events. However, the performance of the filtering-based approaches may depend greatly on the quality of the pre-set list. That is, if the list is poorly maintained, the device may mischaracterize automated scanner events as user (e.g., human) events.

Moreover, the short-term, temporal-based approaches, the filtering-based approaches, and other conventional techniques for identifying automated scanner events from network traffic may have additional limitations. For example, these conventional approaches may rely on very few factors to identify automated scanner events, which may limit the accuracy of automated scanner detection. For example, the temporal-based approaches and filtering-based approaches may rely solely on an email attribute (e.g., an IP address, a user agent) in time. In addition, neither the temporal-based approaches nor the filtering-based approaches may indicate a confidence level that an actor behind an event is either a human or an automated scanner, which may limit a marketer's ability to determine how to modify electronic communications with a particular actor. Additionally, the temporal-based approaches and the filtering-based approaches may fail to adapt overtime, thus failing to consider changing attributes and behavioral features of automated scanner events. As such, it is desirable to develop more robust techniques that pre-process network traffic as known automated scanner events or potential human events to classify activities as being associated with an automated scanner.

In contrast, the data processing system 100 may support techniques for behavior-based detection of automated scanner events via an artificial intelligence system. Specifically, the described techniques for automatic scanner event-detection may account for varying behavioral, temporal, and attribute-based factors while predicting a likelihood that an actor behind an event (e.g., an email engagement) is an automated scanner. An artificial intelligence system (such as an artificial intelligence system hosted at an application server of the data processing system 100) may pre-process network traffic (e.g., a set of input data) into a set of behavioral features associated with an email engagement activity and a set of known automated scanner events. For example, the set of behavioral features may include open rates and click rates, among other tracking features, and the set of known automated scanner events may be based on a pre-established list of IP addresses or user agents of previously-identified automated scanners.

The artificial intelligence system may utilize the pre-processed network traffic in a PU learning model (e.g., machine learning algorithm) that is previously trained on other input data. The PU learning model may output a classification result that classifies an email activity as being performed by a human user or an automated scanner. In classifying the activity, the PU learning model may output a classification result indicating a probability that the activity was associated with an automated scanner. In this way, a marketer may use the artificial intelligence system and the PU learning model for data analysis and predictive purposes. For example, based on the classification result indicating a high probability that an activity is associated with an automated scanner, the marketer may refrain from sending future emails to a source network address corresponding to the automated scanner.

In some examples, a marketer (who may be an employee of an organization) may use the techniques described herein to determine whether a user (e.g., a human user) is engaged with an email, and if the user is engaged with the email, then to develop a marketing strategy based on the engagement. The organization may utilize email security scanners configured to open an incoming email and scan the email and links in the email for malicious content prior to delivering the email to a recipient's inbox. As such, the marketer may better configure a marketing strategy (including different electronic communication messages including marketing emails) if the marketer is able to differentiate human user activity from automated scanner activity. For example, if an electronic communication message activity is classified as being associated with an automated scanner, the marketer may refrain from sending marketing emails to a corresponding source network address and instead may focus marketing efforts to users identified as human users.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

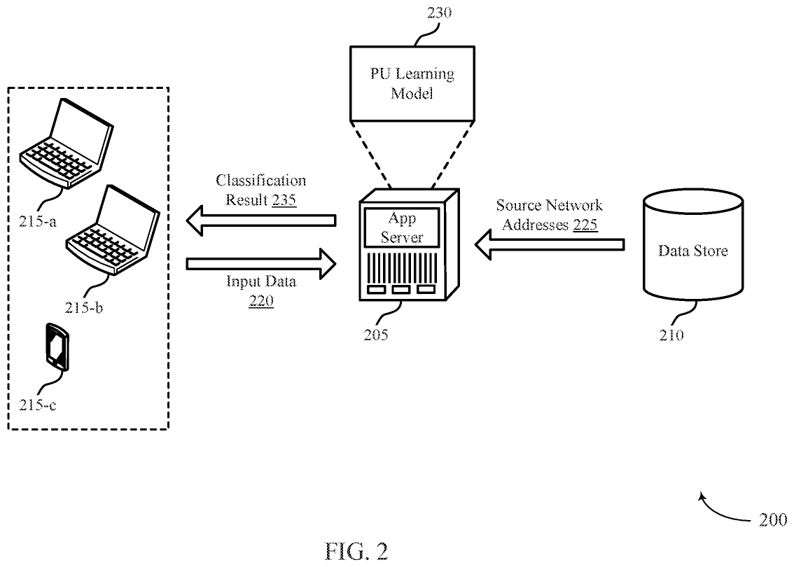

FIG. 2 illustrates an example of a computing architecture 200 that supports behavior-based detection of automated scanner events in accordance with aspects of the present disclosure. The computing architecture 200 may include an application server 205 (e.g., a device), a data store 210, and one or more user devices 215 (e.g., user device 215-a, user device 215-b, and user device 215-c), which may be examples of corresponding devices described herein with reference to FIG. 1. In some cases, the functions performed by the application server 205 may instead be performed by a component of the data store 210, or the user devices 215. In some examples, the application server 205 may support communication with an external server. In addition, the user devices 215 may support an application for data analytics, and the user devices 215 in combination with the external server and the application server 205 may support an application that filters network traffic from automated scanners using pre-processing techniques and artificial intelligence models

In some examples, the application server 205 may receive a set of input data 220 from one or more of the user devices 215. The input data 220 may be associated with an activity, an interaction, or an event between a source network address (e.g., an IP address of a user device 215) and an electronic communication message (e.g., an email). That is, the input data 220 may be associated with network traffic from a user (e.g., a human user) or an automated scanner, for example, interacting with an electronic communication message.

The input data 220 may indicate that a marketing email has been interacted with at a user device 215, which may be associated with a human user or an automated scanner. For example, the input data 220 may indicate a set of features (e.g., engagement tracking features) associated with the activity between the source network address and the electronic communication message. For example, the set of features may include an open rate, a click rate, an open-to-click lag, a send-to-click lag, a traffic burst feature, a tracking pixel feature, or any combination thereof. The rate-related features described herein (e.g., open rate and click rate) may indicate how many emails are opened or clicked on by an actor divided by how many emails were sent to the actor. For example, if a marketer sends a subscriber 10 emails over 30, and if the subscriber opens 5 of the emails and clicks on 3 of the emails, the open rate may be equal to 0.5 and the click rate may be equal to 0.3. In this way, the open rate may indicate how many times an actor (e.g., a human user or an automated scanner) opened an email, and a click rate may indicate how many times the actor clicked on a link in the email.

In addition, an open-to-click lag may indicate a time between an actor opening an email and the actor clicking on a link in the email. The send-to-click lag may indicate a time between a marketer sending an email and the actor clicking on a link in the email. In addition, the traffic burst feature may indicate frequent email opens or link clicks of one or multiple emails within a time period, and the tracking pixel feature may indicate when an image or other pixel in an email is fetched from a database. In some examples, the input data 220 may indicate additional engagement tracking features.

In some examples, the data store 210 may store a list of known automatic scanners. That is, a marketer may collect a list of source network addresses 225 (IP addresses) or other identifying attributes corresponding to previously-identified automated scanners. In some aspects, the application server 205 may identify, from the input data 220, the set of features. In addition, the application server 205 may identify activities that are known to be associated with an automated scanner from the input data 220. That is, the application server 205 may identify a set of source network addresses 225 of respective automated scanners from the input data 220. That is, if the activity indicated in the input data 220 is associated with a source network address 225 included in the pre-set list, the application server 205 may identify that that activity is associated with a known automated scanner. In this way, the application server 205 may pre-process the input data 220 to identify automated scanner events based on the set of features and the composed list of known automated scanners.

The application server 205 may identify the known automated scanner activities based on attributes of the automated scanners (e.g., IP addresses), the set of behavioral features, or both. For example, if an open rate or a click rate is above a particular threshold, the activity may be performed by an automatic scanner. In some other examples, if a link in an email is clicked or a tracking pixel is activated but the email itself is not opened, an actor behind the activity may be an automated scanner. By using the attributes of automated scanners in addition to a variety of behavioral features, such as a click rate and a send-to-click lag among the other engagement tracking features described herein, the application server 205 may define a feature space that includes actor-behaviors (that are more complex and robust to change than attributes such as IP addresses and user agents) and more accurately distinguish automated scanner actors from human users.

In some examples, the application server 205 may use the identified automated scanner events (from the input data 220) to initiate an artificial intelligence model (e.g., a classification model or other machine learning model). The application server 205 may input the set of features and the set of source network addresses 225 into a PU learning model 230 that is trained on previously-received input data. The application server 205 may input the known automated scanner events (e.g., the set of source network addresses 225 of respective automated scanners) into the PU learning model 230 as labeled or positive examples and the remaining events (e.g., identified by the set of features) as unlabeled.

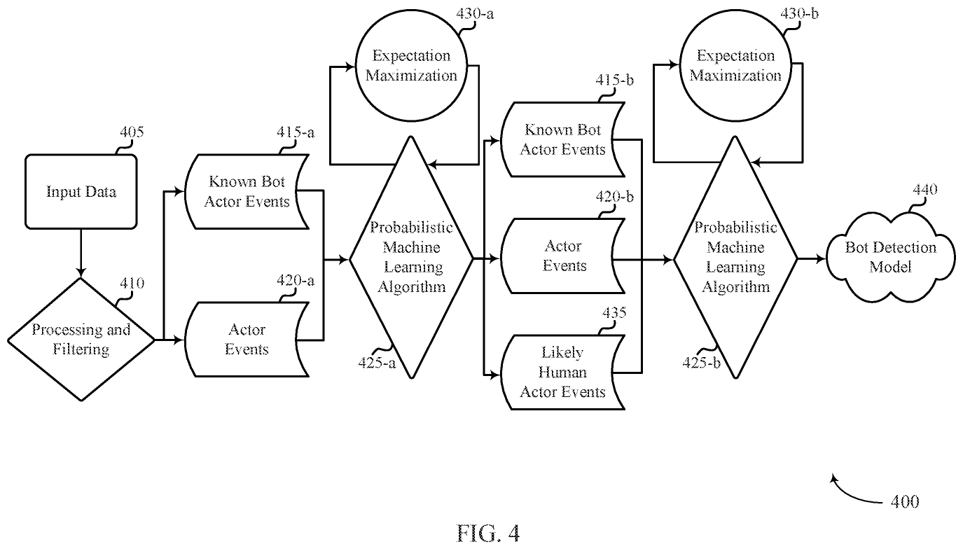

The PU learning model 230, which is described herein with reference to FIG. 4, may utilize a two-step approach to create a binary classifier. A first step may include identifying likely negative examples, and a second step may include building a binary classifier to predict whether a given example is negative or positive. Put another way, in the first step, the PU learning model 230 may identify one or more events or activities included in the input data 220 that are likely to be performed by human users. This may be based on the behavioral features described herein satisfying respective thresholds or otherwise being typical of human users. For example, if an open rate satisfies a threshold (e.g., is below a particular quantity in a given amount of time), the activity may likely be performed by a human user. As such, at the end of the first step, there may still be some activities not yet identified as being performed by a human user or an automated scanner. In the second step, the PU learning model 230 may apply an artificial intelligence algorithm to classify the remaining events as human or automated scanner events.

The artificial intelligence algorithm, which is described in more detail with reference to FIG. 4, may create a model to predict a probability that an actor behind a given event is an automated scanner. When applying the model to a dataset of events or activities (e.g., the input data 220), the application server 205 may identify events that are likely performed by automated scanners and identify associated attributes such as IP addresses (e.g., the source network addresses 225) and user agents. As such, based on executing the PU learning model 230 to classify the event, the application server 205 may output a classification result 235 that indicates the probability that the activity is associated with an automated scanner. In some examples, based on the classification result 235, the application server 205 may update the set of source network addresses 225 of the respective automated scanners. That is, the set of known automated scanners and known automated scanner events may be maintained and updated for future executions of the algorithm as more automated scanner events are identified at a high frequency, which may improve the success of identifying future automated scanner events.

In some cases, marketers may utilize the data pre-processing and artificial intelligence algorithm described herein to filter network traffic from automated scanners. For example, based on a probability that an activity is associated with an automated scanner satisfying a threshold, the application server 205 may determine that the activity is associated with the automated scanner and indicate this in the classification result 235. The threshold may be preconfigured or customized (e.g., by a marketer) for specific cases.

The application server 205 may filter an activity based on a classification result 235 associated with the activity indicating a high probability that the activity is associated with an automated scanner. That is, a marketer may refrain from transmitting particular marketing emails to a source network address that is likely to be associated with an automated scanner. Filtering the activities in this way may improve user engagement data or improve marketing campaigns. For example, the application server 205 may generate a set of user engagement data based on the probability that an activity is associated with an automated scanner, where the user engagement data includes data that is likely to be associated with a human user. As such, the user engagement data may be more accurate and realistic as it may lack misleading data associated with automated scanners.

Additionally, or alternatively, the marketer may generate a set of electronic communication messages (e.g., marketing emails) for transmission to a source network address based on the probability that the activity is associated with the automated scanner. In an example, a marketer may plan a series of emails to send to a customer (e.g., a human user) based on how the customer engages with previous emails. For example, if the customer opens an email and clicks on a link to visit an online store, the marketer may send a follow-up email twenty-four hours later including a discount code to encourage the customer to make a purchase. If the user had not clicked on the link, the marketer may have sent a different follow-up email. Using the described techniques, the marketer may better tailor marketing emails to different recipients in this way based on the probability (or a confidence score) that an activity is associated with an automated scanner.

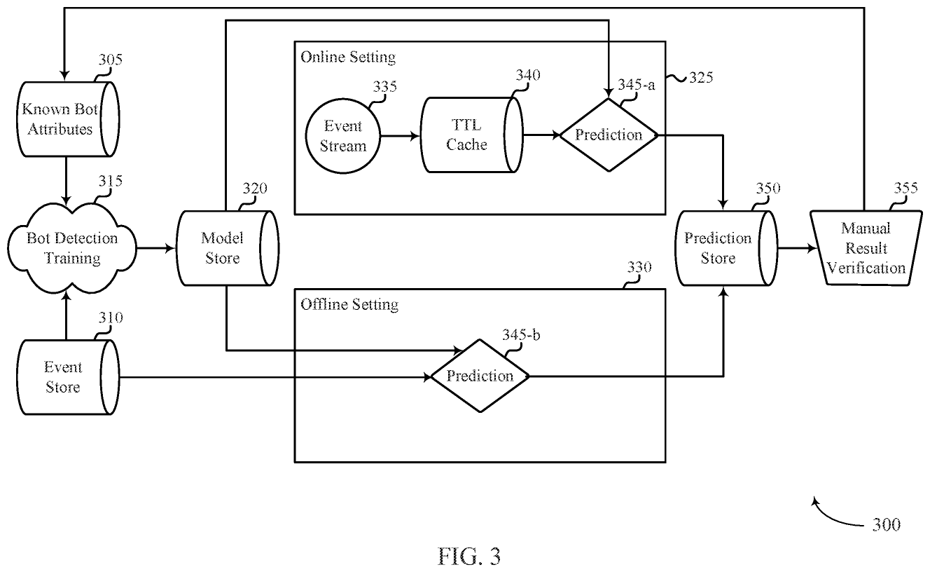

FIG. 3 illustrates an example of a system architecture 300 that supports behavior-based detection of automated scanner events in accordance with aspects of the present disclosure. The system architecture 300 may implement or be implemented by aspects of the data processing system 100 and the computing architecture 200. For example, the system architecture 300 may depict a cyclic process of training a machine learning or artificial intelligence model, using the model in an online or offline setting, and verifying results from the model for future executions of a training algorithm, where the training algorithm may be used to identify activities likely performed by an automated scanner.

The system architecture 300 may be used in both an online setting 325 and an offline setting 330 based on a use case. In some examples, known bot attributes 305 and events from an event store 310 may be input to a bot detection training algorithm 315. The known bot attributes 305 and the events may be identified from input data 220 described herein with reference to FIG. 2. The known bot attributes 305 may include IP addresses (e.g., source network addresses), user agents, or other attributes of known (previously-identified) automated scanners. The event store 310 may include engagement tracking features (e.g., open rates, click rates, open-to-click lags, etc.) associated with events, activities, or interactions between a source network address associated with a user device and an electronic communication message (e.g., an email).

The bot detection training algorithm 315 may be input to a model store 320, which may execute an artificial intelligence model in the online setting 325 or in the offline setting 330 to predict whether an activity is performed by an automated scanner or a human user. For example, the model store 320 may be used to make a prediction 345-a in an online setting 325, which may also take into account an event stream 335 (e.g., input data) that is cached (e.g., in a time to live (TTL) cache 340). In some examples, the prediction 345-a may be associated with a prediction score 350, which may be a probability that an activity is associated with an automated scanner. In an offline setting 330, the model store 320, the event store 310, or both may input information to make a prediction 345-b regarding whether the activity is performed by an automated scanner or a human user. Because of the offline setting 330, the prediction 345-b may not take into account an event stream 335. The prediction 345-b may be associated with the prediction score 350 (which may be a same or a different prediction score as that generated for the online setting 325).

The system architecture 300 may include manual result verification 355 to determine that the activity is performed by an automated scanner or a human user. For example, a marketer may verify that an activity is an automated scanner event if the prediction score 350 (which may be a probability) satisfies a threshold. The manual result verification 355 may be input back into the known bot attributes 305 to improve future executions of the bot detection training algorithm 315. For example, a user (e.g., an engineer, a marketer) may add source network addresses to a list of source network addresses that correspond to an automated scanner.

FIG. 4 illustrates an example of a training algorithm 400 that supports behavior-based detection of automated scanner events in accordance with aspects of the present disclosure. The training algorithm 400 may implement or be implemented by aspects of the data processing system 100 and the computing architecture 200. For example, the training algorithm 400 may include a two-step technique for creating a binary classifier that classifies an activity as being performed by a human user or an automated scanner.

The training algorithm 400 (e.g., a PU learning algorithm) may utilize a probabilistic classifier and be broken up into two primary steps (e.g., a Spy technique) to identify whether an actor behind an electronic communication message activity is a human user or an automated scanner. The PU learning model may utilize a lower-dimensional feature space compared to other techniques, which may improve automated scanner detection.

As described herein with reference to FIG. 2, a first step of the two-step technique may include identifying likely negative examples, and a second step may include building a binary classifier to predict whether a given example is negative or positive. Put another way, in the first step, the PU learning model may identify one or more events or activities included in the input data that are likely to be performed by human users. This may be based on the behavioral features described herein satisfying respective thresholds or otherwise being typical of human users. For example, if an open rate satisfies a threshold (e.g., is below a particular quantity in a given amount of time), the activity may likely be performed by a human user. As such, at the end of the first step, there may still be some activities not yet identified as being performed by a human user or an automated scanner. In the second step, the PU learning model may apply an artificial intelligence algorithm to classify the remaining events as human or automated scanner events. While the following discussion related to a specific technique to execute the training algorithm 400, it should be noted that different algorithms and processes may be used to identify whether an actor behind an electronic communication message activity is a human user or an automated scanner.

Mathematically, the training algorithm 400 may be divided into three components. In the first component, a gradient-boosted trees expectation maximization function (e.g., a probabilistic machine learning algorithm 425 and an expectation maximization function 430) may be applied to the training algorithm 400. Given a set U of unknown actor events and a set of P known automated scanner actor events with associated class labels such that be E U, e_{label}:=c₀ V c₁ and ∀e ∈P, e_{label}:=c₁, an application server (or another device) may compute a model M to predict Pr(e_{label}=c₁|e). The model may train an initial gradient-boosted tree classifier M₀ using U ∪ P to predict the label of a given event such that for e ∈U ∪ P, M(e)→c₀ V c₁. While the feature importances of Mᵢ₋₁ and Mᵢ differ, the model may assign all e ∈U a new label such that e_{label}:=Mᵢ(e) and train Mᵢ₊₁ to predict the label of a given event, e ∈U ∪ P.

The first step of the two-step technique (a second mathematical component of the training algorithm 400) may include identifying likely negative examples using the PU learning model. For example, the first step one may include taking inputs including known bot actor events 415-a and actor events 420-a and converting them into known bot actor events 415-b, actor events 420-b, and likely human actor events 435. Given a set U of unknown actor events and a set P of known automated scanner actor events, a spy sample size s, 0<s<1, and a spy threshold size t, 0<t<1, identify a set of likely human actor events. The model may assign all unknown actor events a negative class label ∀e ∈U, e_{label}=c₀ and all known automated scanner actor events a positive class label ∀e ∈P, e_{label}:=c₁. The model may create a set of “spies” S using random sampling such that ∀e ∈S, e ∈P. and |S|≈s·|P|. In some cases, the model may remove the spies from P such that P=P\S and run a gradient-boosted tree expectation maximization on U and P. The model may compute a spy threshold ϑ using S, t, and M, given by the (|S|*t)ₜₕ smallest value in ∀e ∈S, Pr(M(e)=c₁|e). In some examples, the model may identify the likely human actor events, N, examples in U, where ∀e ∈U, e ∈N⇔Pr(M(e)=c₁|e)<ϑ. The model may remove the likely human examples from U. U=U\N and reintroduce the spies to P.P=P∪S.

The second step of the two-step technique (a third mathematical component of the training algorithm 400) may include building a binary classifier to predict whether a given example is negative or positive. For example, the second step may include converting the known bot actor events 415-b, the actor events 420-b, and the likely human actor events 435 into a bot detection model 440. Given a set N of likely human actor events, a set U of unknown actor events and a set P of known automated scanner actor events, the training algorithm may compute a model to predict Pr (e_{label}=c₁|e). The model may assign all likely human actor events a negative class label ∀e ∈N, e_{label}:=c₀ and all known automated scanner actor events a positive class label ∀e ∈P, e_{label}=c₁. The model may run a gradient-boosted tree expectation maximization on N and P, treating N as U. The model may use M to assign class labels to U, where ∀e ∈U, e_{label}:=M(e) and combine the likely human actor events and unknown actor events U=U ∪ N. The model may run a gradient-boosted tree expectation on U and P. As such, in the training algorithm 400, the application server may use a gradient-boosted tree as a model, however any probabilistic classifier model may work as long as an expectation maximization convergence criteria may be defined.

Using these techniques, the training algorithm 400 may receive input data 405 associated with an activity between a source network address of a user device and an electronic communication message (e.g., a marketing email). The training algorithm 400 may apply to the input data 405 (e.g., the pre-processing described with reference to FIG. 2). Based on the processing and filtering 410, the training algorithm 400 may divide the input data 405 into a set of known bot actor events 415-a (e.g., known automatic scanner actor events) and a set of actor events 420-a, which may be unknown (in terms of whether the actor is a human user or an automated scanner).

During the first step of the two-step algorithm described herein, the known bot actor events 415-a and the actor events 420-a may be input into a probabilistic machine learning algorithm 425-a, which may process the data using the spy technique as described herein. The probabilistic machine learning algorithm 425-a may include expectation maximization 430-a (e.g., a gradient-boosted tree expectation maximization) as described herein.

In addition, during the first step, the probabilistic machine learning algorithm 425-a may output a set of known bot actor events 415-b, a set of actor events 420-b, and a set of likely human actor events 435. That is, the probabilistic machine learning algorithm 425-a may identify events that are performed by human users, likely performed by automated scanners, or likely performed by human users.

During the second step of the two-step algorithm, these sets may be input to a second algorithm, a probabilistic machine learning algorithm 425-b. The probabilistic machine learning algorithm 425-b may include expectation maximization 430-b (e.g., a gradient-boosted tree expectation maximization) as described herein. An output of the probabilistic machine learning algorithm 425-b may be a bot detection model 440 (e.g., an automated scanner detection model) that may generate a classification result that may indicate a probability that an activity is associated with an automated scanner.

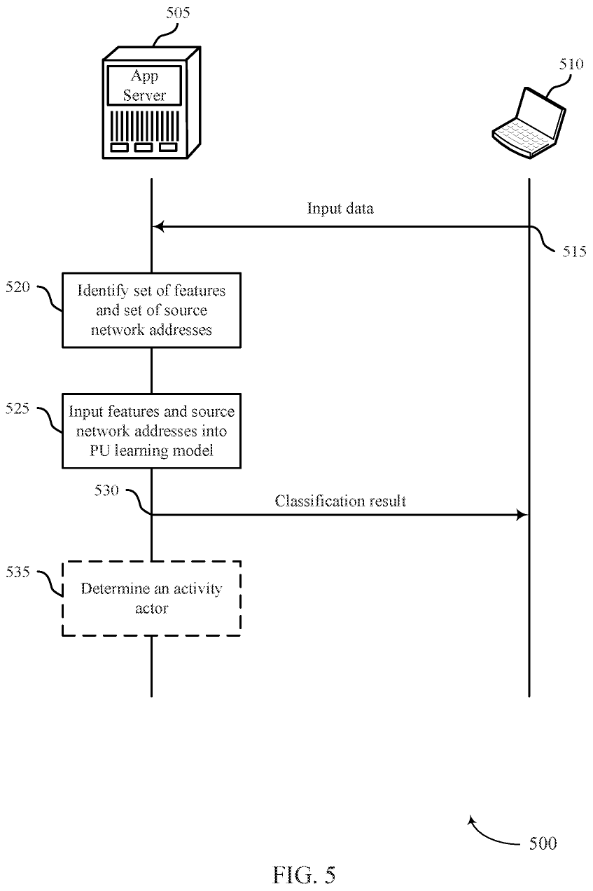

FIG. 5 illustrates an example of a process flow 500 that supports behavior-based detection of automated scanner events in accordance with aspects of the present disclosure. The process flow 500 may implement or be implemented by aspects of the data processing system 100 or the computing architecture 200. For example, the process flow 500 may include an application server 505 and a user device 510, which may be examples of corresponding services and platforms described herein. In the following description of the process flow 500, operations between the application server 505 and the user device 510 be performed in a different order or at a different time than as shown. Additionally, or alternatively, some operations may be omitted from the process flow 500, and other operations may be added to the process flow 500. The process flow 500 may support techniques for generating audience segment fingerprints and performing automatic lookalike (e.g., similarity) discovery.

At 515, the application server 505 may receive a first set of input data associated with an activity between a source network address (e.g., an IP address) and an electronic communication message (e.g., a marketing email). In some examples, the activity may include opening an email, clicking on a link in the email, and the like.

At 520, the application server 505 may identify, from set of input data, a set of features associated with the activity between the source network address and the electronic communication message and a set of source network addresses of respective automated scanners. The set of features may include an open rate, a click rate, an open-to-click lag, a send-to-click lag, a traffic burst feature, a tracking pixel feature, or any combination thereof. In addition, the set of source network addresses of respective automated scanners may match a pre-set list of source network addresses of previously-identified automated scanners.

At 525, the application server 505 may input the set of features associated with the activity and the set of source network addresses into a PU learning machine learning model, where the PU learning machine learning model is trained on a second set of input data. In such cases, the application server 505 may input the set of features associated with the activity into the PU learning machine teaming model as unlabeled events and the set of activities associated with a set of source network addresses into the PU learning machine learning model as positive events.

At 530, the application server 505 may output, for display at the user device 510, a classification result based on executing the PU learning machine learning model to classify the activity, where the classification result indicates a probability that the activity is associated with an automated scanner. For example, the classification result may indicate that the activity has a 50% probability (or some other configurable threshold) of being performed by the automated scanner.

At 535, the application server 505 may determine that the activity is associated with the automated scanner based on the probability satisfying a threshold. For example, if the probability is over 50% (or some other configurable threshold), the activity may be associated with the automated scanner. In some cases, a marketer may use the determination to generate a set of electronic communication messages, generate a set of user engagement data, or filter automated scanners from future electronic communications.

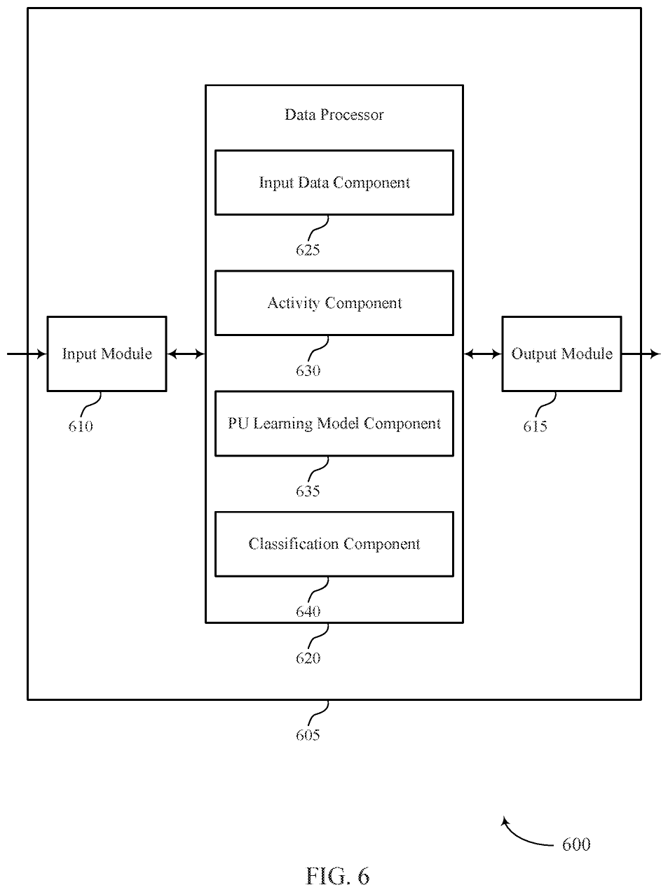

FIG. 6 illustrates a block diagram 600 of a device 605 that supports behavior-based detection of automated scanner events in accordance with aspects of the present disclosure. The device 605 may include an input module 610, an output module 615, and a data processor 620. The device 605 may also include a processor. Each of these components may be in communication with one another (e.g., via one or more buses).

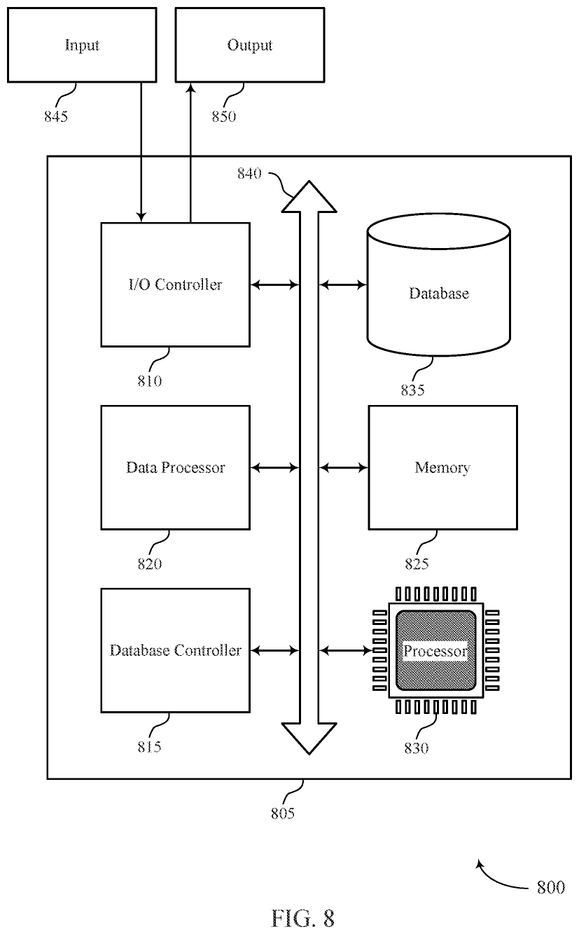

The input module 610 may manage input signals for the device 605. For example, the input module 610 may identify input signals based on an interaction with a modem, a keyboard, a mouse, a touchscreen, or a similar device. These input signals may be associated with user input or processing at other components or devices. In some cases, the input module 610 may utilize an operating system such as iOS®:®, ANDROID®, MS-DOSS®, MS-WINDOWS®®, OS/2*. UNIX®, LINUX®, or another known operating system to handle input signals. The input module 610 may send aspects of these input signals to other components of the device 605 for processing. For example, the input module 610 may transmit input signals to the data processor 620 to support behavior-based detection of automated scanner events. In some cases, the input module 610 may be a component of an I/O controller 810 as described with reference to FIG. 8.

The output module 615 may manage output signals for the device 605. For example, the output module 615 may receive signals from other components of the device 605, such as the data processor 620, and may transmit these signals to other components or devices. In some examples, the output module 615 may transmit output signals for display in a user interface, for storage in a database or data store, for further processing at a server or server cluster, or for any other processes at any number of devices or systems. In some cases, the output module 615 may be a component of an I/O controller 810 as described with reference to FIG. 8.

For example, the data processor 620 may include an input data component 625, an activity component 630, a PU learning model component 635, a classification component 640, or any combination thereof. In some examples, the data processor 620, or various components thereof, may be configured to perform various operations (e.g., receiving, monitoring, transmitting) using or otherwise in cooperation with the input module 610, the output module 615, or both. For example, the data processor 620 may receive information from the input module 610, send information to the output module 615, or be integrated in combination with the input module 610, the output module 615, or both to receive information, transmit information, or perform various other operations as described herein.

The data processor 620 may support data processing in accordance with examples as disclosed herein. The input data component 625 may be configured to support receiving a first set of input data associated with an activity between a source network address and an electronic communication message. The activity component 630 may be configured to support identifying, from set of input data, a set of features associated with the activity between the source network address and the electronic communication message and a set of source network addresses of respective automated scanners. The PU learning model component 635 may be configured to support inputting the set of features associated with the activity and the set of source network addresses into a PU learning machine learning model, where the PU learning machine learning model is trained on a second set of input data. The classification component 640 may be configured to support outputting a classification result based on executing the PU learning machine learning model to classify the activity, where the classification result indicates a probability that the activity is associated with an automated scanner.

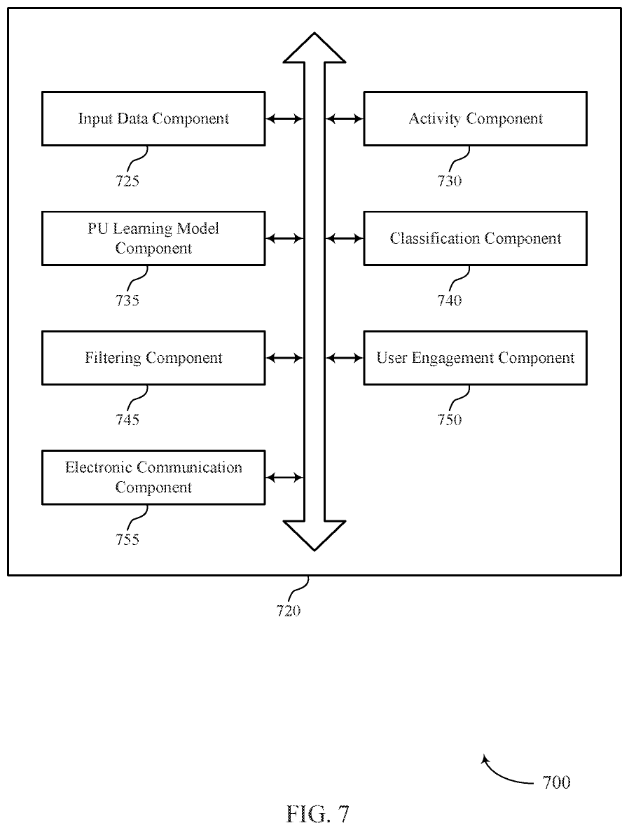

FIG. 7 illustrates a block diagram 700 of a data processor 720 that supports behavior-based detection of automated scanner events in accordance with aspects of the present disclosure. The data processor 720 may be an example of aspects of a data processor or a data processor 620, or both, as described herein. The data processor 720, or various components thereof, may be an example of means for performing various aspects of behavior-based detection of automated scanner events as described herein. For example, the data processor 720 may include an input data component 725, an activity component 730, a PU learning model component 735, a classification component 740, a filtering component 745, a user engagement component 750, an electronic communication component 755, or any combination thereof. Each of these components may communicate, directly or indirectly, with one another (e.g., via one or more buses).

The data processor 720 may support data processing in accordance with examples as disclosed herein. The input data component 725 may be configured to support receiving a first set of input data associated with an activity between a source network address and an electronic communication message. The activity component 730 may be configured to support identifying, from set of input data, a set of features associated with the activity between the source network address and the electronic communication message and a set of source network addresses of respective automated scanners. The PU learning model component 735 may be configured to support inputting the set of features associated with the activity and the set of source network addresses into a PU learning machine learning model, where the PU learning machine teaming model is trained on a second set of input data. The classification component 740 may be configured to support outputting a classification result based on executing the PU learning machine learning model to classify the activity, where the classification result indicates a probability that the activity is associated with an automated scanner.

In some examples, to support inputting the set of features into the PU learning machine learning model, the PU learning model component 735 may be configured to support inputting the set of features associated with the activity into the PU learning machine learning model as unlabeled events and inputting a set of activities associated with a set of source network addresses into the PU learning machine learning model as positive events.

In some examples, to support identifying the set of features and the set of source network addresses, the classification component 740 may be configured to support classifying input data from the set of input data as being associated with a source network address of an automated scanner based on the source network address matching the set of source network addresses of the respective automated scanners.

In some examples, the activity component 730 may be configured to support updating the set of source network addresses of the respective automated scanners based on the classification result. In some examples, the set of features associated with the activity includes an open rate, a click rate, an open-to-click lag, a send-to-click lag, a traffic burst feature, a tracking pixel feature, or any combination thereof.

In some examples, the filtering component 745 may be configured to support filtering the activity from a set of activities based on the classification result indicating a high probability that the activity is associated with the automated scanner.

In some examples, the user engagement component 750 may be configured to support generating a set of user engagement data based on the probability that the activity is associated with the automated scanner.

In some examples, the electronic communication component 755 may be configured to support generating a set of electronic communication messages for transmission to the source network address based on the probability that the source network address is associated with the automated scanner.

In some examples, the classification component 740 may be configured to support determining that the activity is associated with the automated scanner based on the probability satisfying a threshold.

FIG. 8 illustrates a diagram of a system 800 including a device 805 that supports behavior-based detection of automated scanner events in accordance with aspects of the present disclosure. The device 805 may be an example of or include the components of a device 605 as described herein. The device 805 may include components for bi-directional data communications including components for transmitting and receiving communications, such as a data processor 820, an I/O controller 810, a database controller 815, a memory 825, a processor 830, and a database 835. These components may be in electronic communication or otherwise coupled (e.g., operatively, communicatively, functionally, electronically, electrically) via one or more buses (e.g., a bus 840).

The I/O controller 810 may manage input signals 845 and output signals 850 for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®), OS/2®, UNIX®, LINUX®, or another known operating system. In other cases, the I/O controller 810 may represent or interact with a modem, a keyboard, a mouse, a touchscreen, or a similar device. In some cases, the I/O controller 810 may be implemented as part of a processor 830. In some examples, a user may interact with the device 805 via the I/O controller 810 or via hardware components controlled by the I/O controller 810.

The database controller 815 may manage data storage and processing in a database 835. In some cases, a user may interact with the database controller 815. In other cases, the database controller 815 may operate automatically without user interaction. The database 835 may be an example of a single database, a distributed database, multiple distributed databases, a data store, a data lake, or an emergency backup database.

Memory 825 may include random-access memory (RAM) and ROM. The memory 825 may store computer-readable, computer-executable software including instructions that, when executed, cause the processor 830 to perform various functions described herein. In some cases, the memory 825 may contain, among other things, a BIOS which may control basic hardware or software operation such as the interaction with peripheral components or devices.

The processor 830 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 830 may be configured to operate a memory array using a memory controller. In other cases, a memory controller may be integrated into the processor 830. The processor 830 may be configured to execute computer-readable instructions stored in a memory 825 to perform various functions (e.g., functions or tasks supporting behavior-based detection of automated scanner events).

The data processor 820 may support data processing in accordance with examples as disclosed herein. For example, the data processor 820 may be configured to support receiving a first set of input data associated with an activity between a source network address and an electronic communication message. The data processor 820 may be configured to support identifying, from set of input data, a set of features associated with the activity between the source network address and the electronic communication message and a set of source network addresses of respective automated scanners. The data processor 820 may be configured to support inputting the set of features associated with the activity and the set of source network addresses into a PU learning machine learning model, where the PU learning machine learning model is trained on a second set of input data. The data processor 820 may be configured to support outputting a classification result based on executing the PU learning machine learning model to classify the activity, where the classification result indicates a probability that the activity is associated with an automated scanner.

By including or configuring the data processor 820 in accordance with examples as described herein, the device 805 may support techniques for behavior-based detection of automated scanner events, which may improve automated-scanner detection, enable filtering algorithms to adapt over time based on changing automated scanner behaviors, and improve transparence about a probability of detected automated scanner activity.

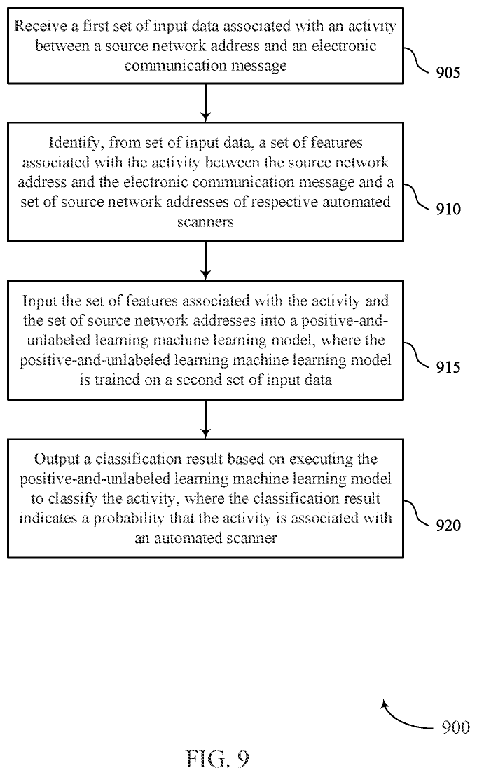

FIG. 9 illustrates a flowchart showing a method 900 that supports behavior-based detection of automated scanner events in accordance with aspects of the present disclosure. The operations of the method 900 may be implemented by a data processor or its components as described herein. For example, the operations of the method 900 may be performed by a data processor as described with reference to FIGS. 1 through 8. In some examples, a data processor may execute a set of instructions to control the functional elements of the data processor to perform the described functions. Additionally, or alternatively, the data processor may perform aspects of the described functions using special-purpose hardware.

At 905, the method may include receiving a first set of input data associated with an activity between a source network address and an electronic communication message. The operations of 905 may be performed in accordance with examples as disclosed herein. In some examples, aspects of the operations of 905 may be performed by an input data component 725 as described with reference to FIG. 7.

At 910, the method may include identifying, from set of input data, a set of features associated with the activity between the source network address and the electronic communication message and a set of source network addresses of respective automated scanners. The operations of 910 may be performed in accordance with examples as disclosed herein. In some examples, aspects of the operations of 910 may be performed by an activity component 730 as described with reference to FIG. 7.

At 915, the method may include inputting the set of features associated with the activity and the set of source network addresses into a PU learning machine teaming model, where the PU learning machine teaming model is trained on a second set of input data. The operations of 915 may be performed in accordance with examples as disclosed herein. In some examples, aspects of the operations of 915 may be performed by a PU learning model component 735 as described with reference to FIG. 7.

At 920, the method may include outputting a classification result based on executing the PU learning machine learning model to classify the activity, where the classification result indicates a probability that the activity is associated with an automated scanner. The operations of 920 may be performed in accordance with examples as disclosed herein. In some examples, aspects of the operations of 920 may be performed by a classification component 740 as described with reference to FIG. 7.

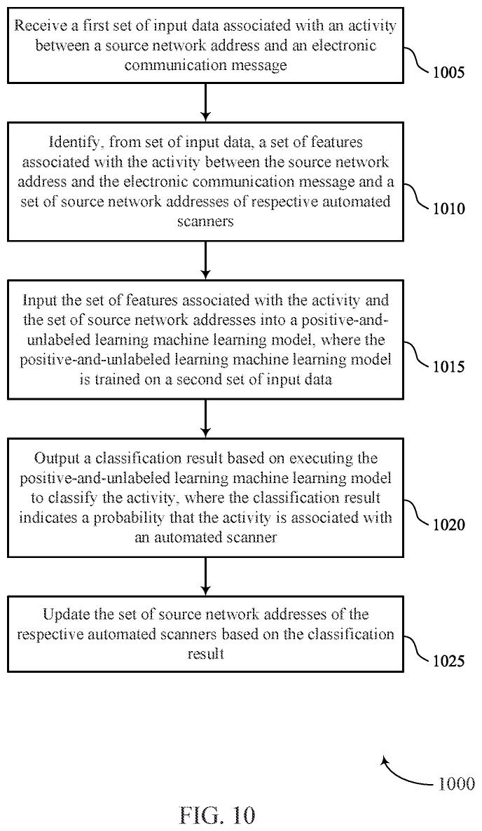

FIG. 10 illustrates a flowchart showing a method 10X) that supports behavior-based detection of automated scanner events in accordance with aspects of the present disclosure. The operations of the method 1000 may be implemented by a data processor or its components as described herein. For example, the operations of the method 1000 may be performed by a data processor as described with reference to FIGS. 1 through 8. In some examples, a data processor may execute a set of instructions to control the functional elements of the data processor to perform the described functions. Additionally, or alternatively, the data processor may perform aspects of the described functions using special-purpose hardware.

At 1005, the method may include receiving a first set of input data associated with an activity between a source network address and an electronic communication message. The operations of 1005 may be performed in accordance with examples as disclosed herein. In some examples, aspects of the operations of 1005 may be performed by an input data component 725 as described with reference to FIG. 7

At 1010, the method may include identifying, from set of input data, a set of features associated with the activity between the source network address and the electronic communication message and a set of source network addresses of respective automated scanners. The operations of 1010 may be performed in accordance with examples as disclosed herein. In some examples, aspects of the operations of 1010 may be performed by an activity component 730 as described with reference to FIG. 7.

At 1015, the method may include inputting the set of features associated with the activity and the set of source network addresses into a PU learning machine learning model, where the PU learning machine learning model is trained on a second set of input data. The operations of 1015 may be performed in accordance with examples as disclosed herein. In some examples, aspects of the operations of 1015 may be performed by a PU learning model component 735 as described with reference to FIG. 7.

At 1020, the method may include outputting a classification result based on executing the PU learning machine learning model to classify the activity, where the classification result indicates a probability that the activity is associated with an automated scanner. The operations of 1020 may be performed in accordance with examples as disclosed herein. In some examples, aspects of the operations of 1020 may be performed by a classification component 740 as described with reference to FIG. 7.

At 1025, the method may include updating the set of source network addresses of the respective automated scanners based on the classification result. The operations of 1025 may be performed in accordance with examples as disclosed herein. In some examples, aspects of the operations of 1025 may be performed by an activity component 730 as described with reference to FIG. 7.

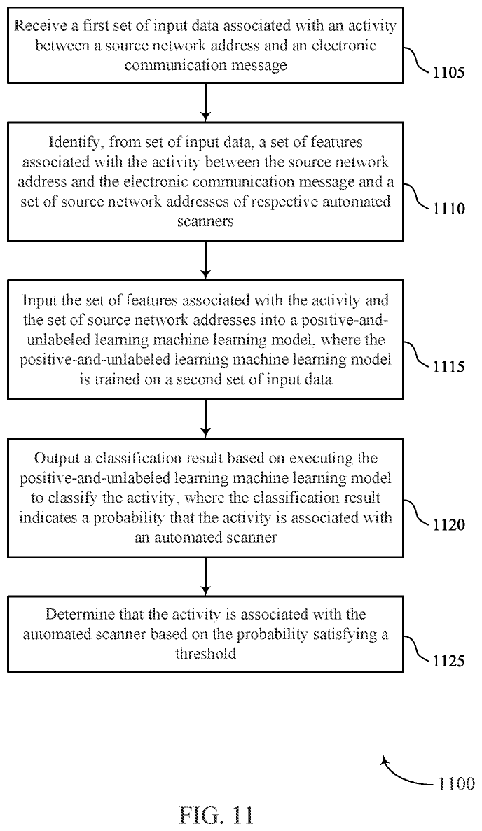

FIG. 11 illustrates a flowchart showing a method 11(x) that supports behavior-based detection of automated scanner events in accordance with aspects of the present disclosure. The operations of the method 1100 may be implemented by a data processor or its components as described herein. For example, the operations of the method 1100 may be performed by a data processor as described with reference to FIGS. 1 through 8. In some examples, a data processor may execute a set of instructions to control the functional elements of the data processor to perform the described functions. Additionally, or alternatively, the data processor may perform aspects of the described functions using special-purpose hardware.

At 1105, the method may include receiving a first set of input data associated with an activity between a source network address and an electronic communication message. The operations of 1105 may be performed in accordance with examples as disclosed herein. In some examples, aspects of the operations of 1105 may be performed by an input data component 725 as described with reference to FIG. 7.

At 1110, the method may include identifying, from set of input data, a set of features associated with the activity between the source network address and the electronic communication message and a set of source network addresses of respective automated scanners. The operations of 1110 may be performed in accordance with examples as disclosed herein. In some examples, aspects of the operations of 1110 may be performed by an activity component 730 as described with reference to FIG. 7.

At 1115, the method may include inputting the set of features associated with the activity and the set of source network addresses into a PU learning machine learning model, where the PU learning machine learning model is trained on a second set of input data. The operations of 1115 may be performed in accordance with examples as disclosed herein. In some examples, aspects of the operations of 1115 may be performed by a PU learning model component 735 as described with reference to FIG. 7.

At 1120, the method may include outputting a classification result based on executing the PU learning machine learning model to classify the activity, where the classification result indicates a probability that the activity is associated with an automated scanner. The operations of 1120 may be performed in accordance with examples as disclosed herein. In some examples, aspects of the operations of 1120 may be performed by a classification component 740 as described with reference to FIG. 7.

At 1125, the method may include determining that the activity is associated with the automated scanner based on the probability satisfying a threshold. The operations of 1125 may be performed in accordance with examples as disclosed herein. In some examples, aspects of the operations of 1125 may be performed by a classification component 740 as described with reference to FIG. 7.

A method for data processing is described. The method may include receiving a first set of input data associated with an activity between a source network address and an electronic communication message, identifying, from set of input data, a set of features associated with the activity between the source network address and the electronic communication message and a set of source network addresses of respective automated scanners, inputting the set of features associated with the activity and the set of source network addresses into a PU learning machine learning model, where the PU learning machine learning model is trained on a second set of input data, and outputting a classification result based on executing the PU learning machine learning model to classify the activity, where the classification result indicates a probability that the activity is associated with an automated scanner.

An apparatus for data processing is described. The apparatus may include a processor, memory coupled with the processor, and instructions stored in the memory. The instructions may be executable by the processor to cause the apparatus to receive a first set of input data associated with an activity between a source network address and an electronic communication message, identify, from set of input data, a set of features associated with the activity between the source network address and the electronic communication message and a set of source network addresses of respective automated scanners, input the set of features associated with the activity and the set of source network addresses into a PU learning machine learning model, where the PU learning machine learning model is trained on a second set of input data, and output a classification result based on executing the PU learning machine learning model to classify the activity, where the classification result indicates a probability that the activity is associated with an automated scanner.

Another apparatus for data processing is described. The apparatus may include means for receiving a first set of input data associated with an activity between a source network address and an electronic communication message, means for identifying, from set of input data, a set of features associated with the activity between the source network address and the electronic communication message and a set of source network addresses of respective automated scanners, means for inputting the set of features associated with the activity and the set of source network addresses into a PU learning machine learning model, where the PU learning machine learning model is trained on a second set of input data, and means for outputting a classification result based on executing the PU learning machine learning model to classify the activity, where the classification result indicates a probability that the activity is associated with an automated scanner

A non-transitory computer-readable medium storing code for data processing is described. The code may include instructions executable by a processor to receive a first set of input data associated with an activity between a source network address and an electronic communication message, identify, from set of input data, a set of features associated with the activity between the source network address and the electronic communication message and a set of source network addresses of respective automated scanners, input the set of features associated with the activity and the set of source network addresses into a PU learning machine learning model, where the PU learning machine learning model is trained on a second set of input data, and output a classification result based on executing the PU learning machine learning model to classify the activity, where the classification result indicates a probability that the activity is associated with an automated scanner.

In some examples of the method, apparatuses, and non-transitory computer-readable medium described herein, inputting the set of features into the PU learning machine learning model may include operations, features, means, or instructions for inputting the set of features associated with the activity into the PU learning machine learning model as unlabeled events and inputting a set of activities associated with a set of source network addresses into the PU learning machine learning model as positive events.

In some examples of the method, apparatuses, and non-transitory computer-readable medium described herein, identifying the set of features and the set of source network addresses may include operations, features, means, or instructions for classifying input data from the set of input data as being associated with a source network address of an automated scanner based on the source network address matching the set of source network addresses of the respective automated scanners.

Some examples of the method, apparatuses, and non-transitory computer-readable medium described herein may further include operations, features, means, or instructions for updating the set of source network addresses of the respective automated scanners based on the classification result.

In some examples of the method, apparatuses, and non-transitory computer-readable medium described herein, the set of features associated with the activity includes an open rate, a click rate, an open-to-click lag, a send-to-click lag, a traffic burst feature, a tracking pixel feature, or any combination thereof.

Some examples of the method, apparatuses, and non-transitory computer-readable medium described herein may further include operations, features, means, or instructions for filtering the activity from a set of activities based on the classification result indicating a high probability that the activity may be associated with the automated scanner.

Some examples of the method, apparatuses, and non-transitory computer-readable medium described herein may further include operations, features, means, or instructions for generating a set of user engagement data based on the probability that the activity may be associated with the automated scanner.

Some examples of the method, apparatuses, and non-transitory computer-readable medium described herein may further include operations, features, means, or instructions for generating a set of electronic communication messages for transmission to the source network address based on the probability that the source network address may be associated with the automated scanner.

Some examples of the method, apparatuses, and non-transitory computer-readable medium described herein may further include operations, features, means, or instructions for determining that the activity may be associated with the automated scanner based on the probability satisfying a threshold.

The following provides an overview of aspects of the present disclosure:

Aspect 1: A method for data processing, comprising: receiving a first set of input data associated with an activity between a source network address and an electronic communication message; identifying, from set of input data, a set of features associated with the activity between the source network address and the electronic communication message and a set of source network addresses of respective automated scanners; inputting the set of features associated with the activity and the set of source network addresses into a PU learning machine learning model, wherein the PU learning machine learning model is trained on a second set of input data; and outputting a classification result based at least in part on executing the PU learning machine learning model to classify the activity, wherein the classification result indicates a probability that the activity is associated with an automated scanner.

Aspect 2: The method of aspect 1, wherein inputting the set of features into the PU learning machine learning model comprises: inputting the set of features associated with the activity into the PU learning machine learning model as unlabeled events and inputting a set of activities associated with a set of source network addresses into the PU learning machine learning model as positive events.

Aspect 3: The method of any of aspects 1 through 2, wherein identifying the set of features and the set of source network addresses comprises: classifying input data from the set of input data as being associated with a source network address of an automated scanner based at least in part on the source network address matching the set of source network addresses of the respective automated scanners.

Aspect 4: The method of any of aspects 1 through 3, further comprising: updating the set of source network addresses of the respective automated scanners based at least in part on the classification result.

Aspect 5: The method of any of aspects 1 through 4, wherein the set of features associated with the activity comprises an open rate, a click rate, an open-to-click lag, a send-to-click lag, a traffic burst feature, a tracking pixel feature, or any combination thereof.

Aspect 6: The method of any of aspects 1 through 5, further comprising: filtering the activity from a set of activities based at least in part on the classification result indicating a high probability that the activity is associated with the automated scanner.

Aspect 7: The method of any of aspects 1 through 6, further comprising: generating a set of user engagement data based at least in part on the probability that the activity is associated with the automated scanner.

Aspect 8: The method of any of aspects 1 through 7, further comprising: generating a set of electronic communication messages for transmission to the source network address based at least in part on the probability that the source network address is associated with the automated scanner.

Aspect 9: The method of any of aspects 1 through 8, further comprising: determining that the activity is associated with the automated scanner based at least in part on the probability satisfying a threshold.

Aspect 10: An apparatus for data processing, comprising a processor; memory coupled with the processor; and instructions stored in the memory and executable by the processor to cause the apparatus to perform a method of any of aspects 1 through 9.

Aspect 11: An apparatus for data processing, comprising at least one means for performing a method of any of aspects 1 through 9.

Aspect 12: A non-transitory computer-readable medium storing code for data processing, the code comprising instructions executable by a processor to perform a method of any of aspects 1 through 9.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as at least one of or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for data processing, comprising:
receiving a first set of input data associated with an activity between a source network address and an electronic communication message;
identifying, from set of input data, a set of features associated with the activity between the source network address and the electronic communication message and a set of source network addresses of respective automated scanners;
determining a set of activities associated with automated scanners based at least in part on the set of features and the set of source network addresses;
inputting the set of features associated with the activity, the set of source network addresses, and the set of activities into a positive-and-unlabeled learning machine learning model, wherein the positive-and-unlabeled learning machine learning model is trained on a second set of input data associated with a set of labeled automated scanner events between the source network address and a second electronic communication message different from the set of activities associated with automated scanners;
outputting a classification result based at least in part on executing the positive-and-unlabeled learning machine learning model to classify the activity, wherein the classification result indicates a probability that the activity is associated with an automated scanner; and
generating a first set of electronic communication messages for transmission to the source network address based at least in part on the probability satisfying a threshold, wherein the generating comprises refraining from generating a second set of electronic communication messages for transmission to the source network address based at least in part on the probability failing to satisfy the threshold.

2. The method of claim 1, wherein inputting the set of features into the positive-and-unlabeled learning machine learning model comprises:
inputting the set of features associated with the activity into the positive-and-unlabeled learning machine learning model as unlabeled events and inputting a set of activities associated with a set of source network addresses into the positive-and-unlabeled learning machine learning model as positive events.

3. The method of claim 1, wherein identifying the set of features and the set of source network addresses comprises:
classifying input data from the set of input data as being associated with a source network address of an automated scanner based at least in part on the source network address matching the set of source network addresses of the respective automated scanners.

4. The method of claim 1, further comprising:
updating the set of source network addresses of the respective automated scanners based at least in part on the classification result.

5. The method of claim 1, wherein the set of features associated with the activity comprises an open rate, a click rate, an open-to-click lag, a send-to-click lag, a traffic burst feature, a tracking pixel feature, or any combination thereof.

6. The method of claim 1, further comprising:
filtering the activity from a set of activities based at least in part on the classification result indicating a probability that fails to satisfy the threshold, wherein the probability failing to satisfy the threshold indicates that the activity is associated with the automated scanner.

7. The method of claim 1, further comprising:
generating a set of user engagement data based at least in part on the probability that the activity is associated with the automated scanner.

8. The method of claim 1,
wherein the probability failing to satisfy the threshold indicates that the source network address is associated with the automated scanner.

9. The method of claim 1, further comprising:
determining that the activity is associated with the automated scanner based at least in part on the probability failing to satisfy the threshold.

10. An apparatus for data processing, comprising:
a processor;
memory coupled with the processor; and
instructions stored in the memory and executable by the processor to cause the apparatus to:
receive a first set of input data associated with an activity between a source network address and an electronic communication message;
identify, from set of input data, a set of features associated with the activity between the source network address and the electronic communication message and a set of source network addresses of respective automated scanners;
determine a set of activities associated with automated scanners based at least in part on the set of features and the set of source network addresses;
input the set of features associated with the activity, the set of source network addresses, and the set of activities into a positive-and-unlabeled learning machine learning model, wherein the positive-and-unlabeled learning machine learning model is trained on a second set of input data associated with a set of labeled automated scanner events between the source network address and a second electronic communication message different from the set of activities associated with automated scanners;
output a classification result based at least in part on executing the positive-and-unlabeled learning machine learning model to classify the activity, wherein the classification result indicates a probability that the activity is associated with an automated scanner; and
generate a first set of electronic communication messages for transmission to the source network address based at least in part on the probability satisfying a threshold, wherein the generating comprises refraining from generating a second set of electronic communication messages for transmission to the source network address based at least in part on the probability failing to satisfy the threshold.

11. The apparatus of claim 10, wherein the instructions to input the set of features into the positive-and-unlabeled learning machine learning model are executable by the processor to cause the apparatus to:
input the set of features associated with the activity into the positive-and-unlabeled learning machine learning model as unlabeled events and inputting a set of activities associated with a set of source network addresses into the positive-and-unlabeled learning machine learning model as positive events.

12. The apparatus of claim 10, wherein the instructions to identify the set of features and the set of source network addresses are executable by the processor to cause the apparatus to:
classify input data from the set of input data as being associated with a source network address of an automated scanner based at least in part on the source network address matching the set of source network addresses of the respective automated scanners.

13. The apparatus of claim 10, wherein the instructions are further executable by the processor to cause the apparatus to:
update the set of source network addresses of the respective automated scanners based at least in part on the classification result.

14. The apparatus of claim 10, wherein the set of features associated with the activity comprises an open rate, a click rate, an open-to-click lag, a send-to-click lag, a traffic burst feature, a tracking pixel feature, or any combination thereof.

15. The apparatus of claim 10, wherein the instructions are further executable by the processor to cause the apparatus to:
filter the activity from a set of activities based at least in part on the classification result indicating a high probability that fails to satisfy the threshold, wherein the probability failing to satisfy the threshold indicates that the activity is associated with the automated scanner.

16. The apparatus of claim 10, wherein the instructions are further executable by the processor to cause the apparatus to:
generate a set of user engagement data based at least in part on the probability that the activity is associated with the automated scanner.

17. The apparatus of claim 10, wherein the probability failing to satisfy the threshold indicates that the source network address is associated with the automated scanner.

18. The apparatus of claim 10, wherein the instructions are further executable by the processor to cause the apparatus to:
determine that the activity is associated with the automated scanner based at least in part on the probability failing to satisfy the threshold.

19. A non-transitory computer-readable medium storing code for data processing, the code comprising instructions executable by a processor to:
receive a first set of input data associated with an activity between a source network address and an electronic communication message;
identify, from set of input data, a set of features associated with the activity between the source network address and the electronic communication message and a set of source network addresses of respective automated scanners;
determine a set of activities associated with automated scanners based at least in part on the set of features and the set of source network addresses;
input the set of features associated with the activity, the set of source network addresses, and the set of activities into a positive-and-unlabeled learning machine learning model, wherein the positive-and-unlabeled learning machine learning model is trained on a second set of input data associated with a set of labeled automated scanner events between the source network address and a second electronic communication message different from the set of activities associated with automated scanners;
output a classification result based at least in part on executing the positive-and-unlabeled learning machine learning model to classify the activity, wherein the classification result indicates a probability that the activity is associated with an automated scanner; and
generate a first set of electronic communication messages for transmission to the source network address based at least in part on the probability satisfying a threshold, wherein the generating comprises refraining from generating a second set of electronic communication messages for transmission to the source network address based at least in part on the probability failing to satisfy the threshold.

20. The non-transitory computer-readable medium of claim 19, wherein the instructions to input the set of features into the positive-and-unlabeled learning machine learning model are executable by the processor to:
input the set of features associated with the activity into the positive-and-unlabeled learning machine learning model as unlabeled events and inputting a set of activities associated with a set of source network addresses into the positive-and-unlabeled learning machine learning model as positive events.
